(19) United States
(12) Patent Application Publication
(10) Pub. No.: US 2015/0004855 A1
(43) Pub. Date: Jan. 1, 2015

(54) GEAR CASE ASSEMBLY FOR AN OUTBOARD ENGINE

(71) Applicant: BRP US INC., Sturtevant, WI (US)

(72) Inventors: Darrell WIATROWSKI, Libertyville, IL (US); Mark C. NOBLE, Pleasant Prairie, WI (US); Mike DAVENPORT, Pleasant Prairie, WI (US)

(73) Assignee: BRP US INC., Sturtevant, WI (US)

(21) Appl. No.: 14/319,221

(22) Filed: Jun. 30, 2014

Related U.S. Application Data
(60) Provisional application No. 61/841,026, filed on Jun. 28, 2013.

(51) Int. Cl. B63H 20/20; B63H 23/24; B63H 23/30; F16H 3/02; B63H 20/32

(52) U.S. Cl. CPC B63H 20/20; F16H 3/02; B63H 20/32; B63H 23/30; B63H 23/24; B63H 2020/323
USPC 440/75; 74/335

(57) ABSTRACT

A gear case assembly for an outboard engine has a gear case, a driveshaft having a part disposed within the gear case, a bevel gear connected to the part of the driveshaft, a propeller shaft, and a transmission operatively connected to the bevel gear. The bevel gear selectively drives the propeller shaft via the transmission. The transmission has forward and reverse gears operatively connected to the bevel gear, and a shift assembly adapted for actuation by a shift actuator. The shift assembly has first and second rod portions and at least one resilient member. The at least one resilient member operatively connects the first rod portion to the second rod portion. The first rod portion is movable relative to the second rod portion.

### CROSS-REFERENCE

The present application claims priority to U.S. Provisional Patent Application No. 61/841,026, filed Jun. 28, 2013, the entirety of which is incorporated herein by reference.

### FIELD OF TECHNOLOGY

The present technology relates to a gear case assembly for an outboard engine used to propel a watercraft.

### BACKGROUND

The propellers of many marine outboard engines can be operated in two opposite directions of rotation resulting in forward or reverse motion of the watercraft. The propeller is mounted on a propeller shaft and operated by rotation of the propeller shaft by a rotating driveshaft extending from the engine. The propeller shaft is attached to a transmission that converts rotation of the driveshaft to rotation of the propeller shaft that is disposed perpendicularly to the driveshaft.

A linear or rotary actuator is used to selectively actuate the transmission thereby placing the propeller shaft in forward, reverse or neutral operating conditions. Whether actuated with a linear actuator or a rotary actuator, the actuator is typically mounted in the midsection or the power head. A vertical coupling rod extending down from the actuator through the midsection couples the actuator with the transmission for actuation of the transmission.

In some implementations, the transmission includes a sleeve having a pair of outwardly and oppositely facing toothed ends, sometimes referred to as a clutch dog. By translating the sleeve using the actuator, each of the toothed ends selectively engages with the teeth of a corresponding one of two gears. One gear is engaged to put the transmission in a forward operating condition and the other gear is engaged to put the transmission in a reverse operating condition.

It is possible that when translating the sleeve the teeth of the toothed end do not align with the space between the teeth of the gear to be engaged. The sets of teeth will eventually align, and thereby engage with each other due to their rotation relative to each other prior to engagement. Before the sets of teeth engage each other, the teeth of the toothed end come into contact with the teeth of the gear to be engaged. This impact can result in a loud noise and could eventually result in damages to the transmission, in particular in transmissions with short or few mechanical linkages.

Therefore there is a need for a gear case for an outboard engine having a shifting system that can reduce the effects resulting from misaligned teeth when engaging one of the gears of the transmission.

### SUMMARY

It is an object of the present technology to ameliorate at least some of the inconveniences present in the prior art.

According to one aspect of the present technology, there is provided a gear case assembly for an outboard engine for propelling a watercraft is provided. The outboard engine has a shift actuator. The gear case assembly has a gear case, a driveshaft, a part of the driveshaft being disposed within the gear case, a bevel gear connected to the part of the driveshaft and being rotatable therewith, the bevel gear being disposed within the gear case, a propeller shaft disposed at least in part within the gear case and at an angle to the driveshaft, and a transmission being operatively connected to the bevel gear. The bevel gear selectively drives the propeller shaft via the transmission. The transmission has a forward gear operatively connected to the bevel gear for selectively driving the propeller shaft in a first direction of rotation for propelling the watercraft in a forward direction, a reverse gear operatively connected to the bevel gear for selectively driving the propeller shaft in a second direction of rotation opposite the first direction of rotation for propelling the watercraft in a reverse direction, and a shift assembly being adapted for actuation by the shift actuator for the selective driving of the propeller shaft by one of the forward and reverse gears. The shift assembly includes a first rod portion, a second rod portion and at least one resilient member. The at least one resilient member operatively connects the first rod portion to the second rod portion. The first rod portion is movable relative to the second rod portion.

In some implementations of the present technology, the shift assembly has a shift rod disposed parallel to the driveshaft and being disposed at least in part within the gear case, the shift rod being adapted for actuation by the shift actuator, a clutch rod disposed at an angle to the shift rod, and a rocker operatively connecting the shift rod to the clutch rod for transferring motion of the shift rod to the clutch rod. One of the shift rod and the clutch rod includes the first rod portion, the second rod portion and the at least one resilient member.

In some implementations of the present technology, the at least one resilient member is at least one spring.

In some implementations of the present technology, the shift rod has the first rod portion, the second rod portion and the at least one spring. The first rod portion is a first shift rod portion and the second rod portion is a second shift rod portion. The first shift rod portion has a first abutment surface. The second shift rod portion has a second abutment surface and defines a spring chamber. The first abutment surface of the first shift rod portion is received in the spring chamber. At least one of the at least one spring is disposed in the spring chamber between the first and second abutment surfaces.

In some implementations of the present technology, a first washer is disposed between the first abutment surface and the at least one of the at least one spring. The second abutment surface is defined by a second washer.

In some implementations of the present technology, a pin is inserted in the first and second shift rod portions and prevents rotation of the first and second shift rod portions relative to each other about an actuation axis of the shift rod assembly.

In some implementations of the present technology, the at least one of the at least one spring is disposed on a first side of the first abutment surface. At least another one of the at least one spring is disposed in the spring chamber between the first abutment surface and the second shift rod portion on a second side of the first abutment surface.

In some implementations of the present technology, the gear case assembly includes the shift actuator. The shift actuator has an electric transmission actuator assembly selectively actuating the shift assembly. The gear case has an actuator chamber housing at least part of the electric transmission actuator assembly.

In some implementations of the present technology, the shift rod is actuated linearly about an actuation axis parallel to the driveshaft.

In some implementations of the present technology, the clutch rod has the first rod portion, the second rod portion and the at least one resilient member. The first rod portion is a first clutch rod portion and the second rod portion is a second clutch rod portion.

According to another aspect of the present technology, there is provided an outboard engine for propelling a watercraft has a cowling, an engine disposed in the cowling, a driveshaft disposed in the cowling, the driveshaft having at least an upper section and a lower section, the upper section of the driveshaft being operatively connected to the engine, a gear case connected to the cowling, a part of the lower section of the driveshaft being disposed within the gear case, a bevel gear connected to the part of the lower section of the driveshaft and being rotatable therewith, the bevel gear being disposed within the gear case, a propeller shaft disposed at least in part within the gear case and at an angle to the driveshaft, a bladed rotor connected to the propeller shaft, and a transmission being operatively connected to the bevel gear. The bevel gear selectively drives the propeller shaft via the transmission. The transmission has a forward gear selectively operatively connected to the bevel gear for driving the propeller shaft in a first direction of rotation for propelling the watercraft in a forward direction, a reverse gear selectively operatively connected to the bevel gear for driving the propeller shaft in a second direction of rotation opposite the first direction of rotation for propelling the watercraft in a reverse direction, and a shift actuator operatively connected to a shift assembly. The shift actuator is adapted for actuating the shift assembly for the selective driving of the propeller shaft by one of the forward and reverse gears. The shift assembly includes a first rod portion, a second rod portion and at least one resilient member. The at least one resilient member operatively connects the first rod portion to the second rod portion. The first rod portion is movable relative to the second rod portion.

In some implementations of the present technology, the shift assembly has a shift rod disposed parallel to the driveshaft and being disposed at least in part within the gear case, the shift rod being adapted for actuation by the shift actuator, a clutch rod disposed at an angle to the shift rod, and a rocker operatively connecting the shift rod to the clutch rod for transferring motion of the shift rod to the clutch rod. One of the shift rod and the clutch rod includes the first rod portion, the second rod portion and the at least one resilient member.

In some implementations of the present technology, the at least one resilient member is at least one spring.

In some implementations of the present technology, the shift rod has the first rod portion, the second rod portion and the at least one spring. The first rod portion is a first shift rod portion and the second rod portion is a second shift rod portion. The first shift rod portion has a first abutment surface. The second shift rod portion has a second abutment surface and defines a spring chamber. The first abutment surface of the first shift rod portion is received in the spring chamber. At least one of the at least one spring is disposed in the spring chamber between the first and second abutment surfaces.

In some implementations of the present technology, a first washer is disposed between the first abutment surface and the at least one of the at least one spring. The second abutment surface is defined by a second washer.

In some implementations of the present technology, a pin is inserted in the first and second shift rod portions and prevents rotation of the first and second shift rod portions relative to each other about an actuation axis of the shift rod assembly.

In some implementations of the present technology, the at least one of the at least one spring is disposed on a first side of the first abutment surface. At least another one of the at least one spring is disposed in the spring chamber between the first abutment surface and the second shift rod portion on a second side of the first abutment surface.

In some implementations of the present technology, the shift actuator has an electric transmission actuator assembly selectively actuating the shift assembly. The gear case has an actuator chamber housing at least part of the electric transmission actuator assembly.

In some implementations of the present technology, the shift rod is actuated linearly about an actuation axis parallel to the driveshaft.

In some implementations of the present technology, the clutch rod has the first rod portion, the second rod portion and the at least one resilient member. The first rod portion is a first clutch rod portion and the second rod portion is a second clutch rod portion.

For purposes of the present application, terms related to spatial orientation when referring to an outboard engine and components in relation to the outboard engine, such as “front”, “rear”, “left”, “right”, “above” and “below”, are as they would be understood by a driver of a boat to which the outboard engine is connected, with the outboard engine connected to the stern of the boat, in a straight ahead orientation (i.e. not steered left or right), and in an upright position (i.e. not tilted and not trimmed).

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an outboard engine mounted to a stern of a boat;

FIG. 2 is a partial, vertical cross-sectional view of a gear case assembly of the outboard engine of FIG. 1;

FIG. 3 is a close-up view of a vertical cross-section of a lower front portion of the gear case assembly of FIG. 2;

FIG. 4 is a rear elevation view of a portion of a shift rod of the gear case assembly of FIG. 2;

FIG. 5 is a cross-sectional view of the portion of the shift rod of FIG. 4 taken through line 5-5 of FIG. 4;

FIG. 6 is a close-up view of section 6-6 of the cross-sectional view of FIG. 5;

FIG. 7 is a perspective view of a cross-section of the shift rod of FIG. 4 taken through a line perpendicular to the line 5-5 of FIG. 4;

FIG. 8 is a rear elevation view of an alternative implementation of a shift rod;

FIG. 9 is a cross-sectional view of the shift rod of FIG. 8 taken through line 9-9 of FIG. 8;

FIG. 10 is a close-up view of section 10-10 of the cross-sectional view of FIG. 9; and

FIG. 11 is a left side elevation view of an alternative implementation of a clutch rod.

### DETAILED DESCRIPTION

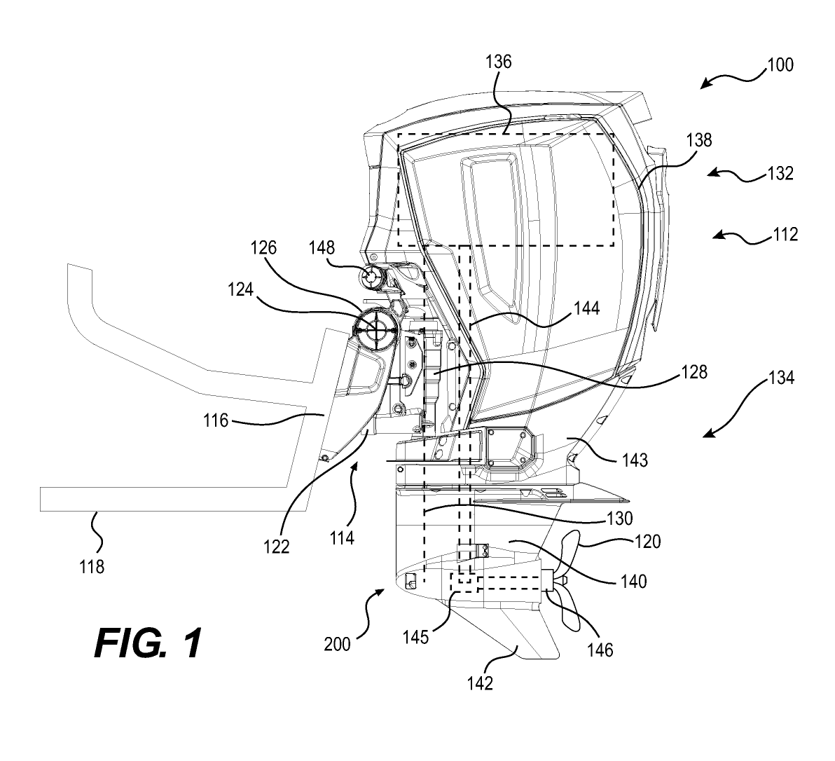

With reference to FIG. 1, an outboard engine 100, shown in the upright position, includes a drive unit 112 and a bracket assembly 114. The bracket assembly 114 supports the drive unit 112 on a transom 116 of a hull 118 of an associated watercraft (not shown) such that a propeller 120 is in a submerged position with the watercraft resting relative to a surface of a body of water. The drive unit 112 can be trimmed up or down relative to the hull 118 by linear actuators 122 of the bracket assembly 114 about a tilt/trim axis 124 extending generally horizontally. The drive unit 112 can also be tilted up or down relative to the hull 118 by a rotary actuator 126 of the bracket assembly 114 about the tilt/trim axis 124. The drive unit 112 can also be steered left or right relative to the hull 118 by another rotary actuator 128 of the bracket assembly 114 about a steering axis 130. The steering axis 130 extends generally perpendicularly to the tilt/trim axis 124. When the drive unit 112 is in the upright position as shown in FIG. 1, the steering axis 130 extends generally vertically.

The drive unit 112 includes an upper portion 132 and a lower portion 134. The upper portion 132 includes an engine 136 (schematically shown in dotted lines) surrounded and protected by a cowling 138. The engine 136 housed within the cowling 138 is an internal combustion engine, such as a two-stroke or four-stroke engine, having cylinders extending generally horizontally when the drive unit 112 is in an upright position as shown. It is contemplated that other types of engines could be used and that the cylinders could be oriented differently. The lower portion 134 includes the gear case assembly 200, which includes a gear case 140, the propeller 120, and the skeg portion 142. A midsection 143 is connected between the engine 136 and the gear case 140. It is contemplated that the midsection 143 could house a portion of an exhaust system of the outboard engine 100.

The engine 136 is coupled to a driveshaft 144 (schematically shown in dotted lines in FIG. 1). When the drive unit 112 is in the upright position, the driveshaft 144 is oriented vertically. It is contemplated that the driveshaft 144 could be oriented differently relative to the engine 136. The driveshaft 144 is disposed in the cowling 138, passes through the midsection 143 and is coupled to a drive mechanism, which includes a transmission 145 and the propeller 120 mounted on a propeller shaft 146 as will be discussed in greater detail below. It is contemplated that the driveshaft 144 could not pass through the midsection 143. In FIG. 1, the propeller shaft 146 is perpendicular to the driveshaft 144. It is contemplated that the propeller shaft 146 could be disposed at other angles relative to the driveshaft 144. The driveshaft 144 and the transmission 145 transfer the power of the engine 136 to the propeller 120 mounted on the rear side of the gear case 140 of the drive unit 112. It is contemplated that the propulsion system of the outboard engine 100 could alternatively include a jet propulsion device, turbine or other known propelling device. It is further contemplated that the bladed rotor could alternatively be an impeller.

To facilitate the installation of the outboard engine 100 on the watercraft, the outboard engine 100 is provided with a connection box 148. The connection box 148 is connected on top of the rotary actuator 126. As a result, the connection box 148 pivots about the tilt/trim axis 124 when the drive unit 112 is tilted, but does not pivot about the steering axis 130 when the drive unit 112 is steered. It is contemplated that the connection box 148 could be mounted elsewhere on the bracket assembly 114 or on the drive unit 112. Devices located inside the cowling 138 which need to be connected to other devices disposed externally of the outboard engine 100, such as on the deck or hull 118 of the watercraft, are provided with lines which extend inside the connection box 148. Similarly, the corresponding devices disposed externally of the outboard engine 100 are also provided with lines that extend inside the connection box 148 where they are connected with their corresponding lines from the outboard engine 100. It is contemplated that one or more lines could be connected between one or more devices located inside the cowling 138 to one or more devices located externally of the outboard engine 100 and simply pass through the connection box 148. It is contemplated that the connection box 148 could be omitted.

Other known components of an engine assembly are included within the cowling 138, such as a starter motor, an alternator and the exhaust system. As it is believed that these components would be readily recognized by one of ordinary skill in the art, further explanation and description of these components will not be provided herein.

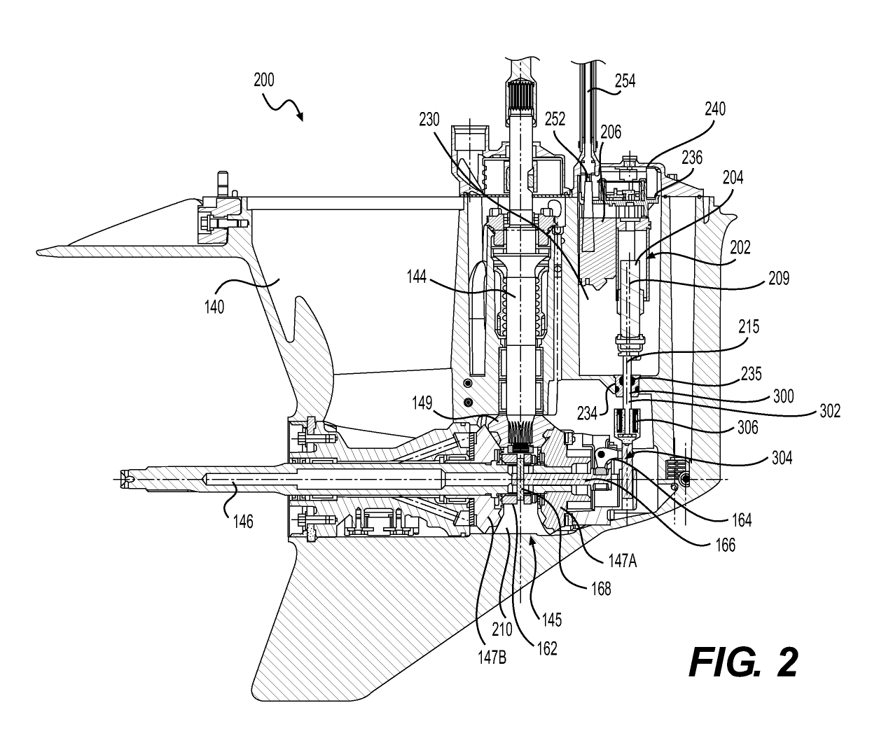

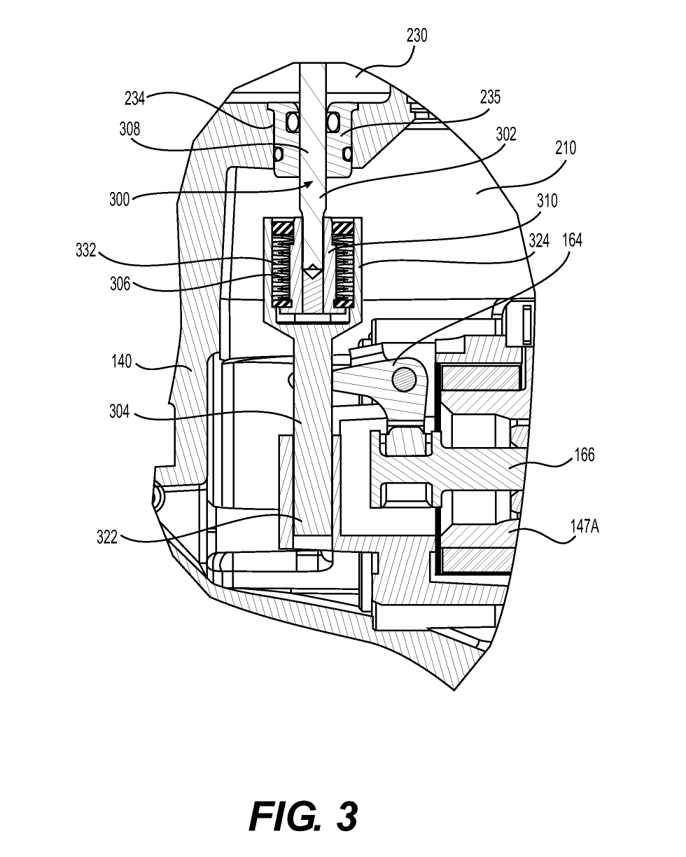

The gear case assembly 200 will now be described in more detail with reference to FIGS. 2 and 3. The gear case assembly 200 is shown in the figures in its upright position which corresponds to the position of the gear case assembly 200 when the outboard engine 100 is positioned as shown in FIG. 1. The gear case assembly 200 includes the gear case 140 which houses portions of the driveshaft 144, the propeller shaft 146, the transmission 145 and an electric transmission actuator assembly 202. A portion of the lower section of the driveshaft 144 is mounted vertically near a longitudinal center of the gear case 140 (with reference to the outboard engine 100 being in an upright position as shown in the figures). The propeller shaft 146 is mounted in an orientation perpendicular to the driveshaft 144 and is selectively connected to the transmission 145. The transmission 145 is also coupled to the bottom of the driveshaft 144. As mentioned above, the propeller 120 is connected to the rear end of the propeller shaft 146.

Two oppositely facing bevel gears 147A, 147B of the transmission 145 are engaged to opposite sides of a complementary bevel gear 149 at the bottom of the lower section of the driveshaft 144. The bevel gears 147A, 147B rotate with the driveshaft 144 but in directions opposite to each other. Each bevel gear 147A, 147B of the transmission 145 has a toothed face, the two faces being inwardly and oppositely facing. The propeller shaft 146 is in splined connection with a sleeve 162 having a pair of outwardly and oppositely facing toothed ends. The outwardly facing toothed ends of the sleeve 162 are selectively engaged with an adjacent inwardly facing toothed face of the bevel gears 147A, 147B by translation of the sleeve 162 along the propeller shaft 146. Engagement of the sleeve 162 with a bevel gear 147A, 147B on either side results in rotation of the propeller shaft 146 along with that bevel gear 147A or 147B corresponding to forward or reverse rotation of the propeller shaft 146. The sleeve 162 being in a position in the middle disengaged from both bevel gears 147A, 147B corresponds to a neutral operating condition of the gear case assembly 200 with no rotation of the propeller shaft 146.

A shift rod 300 is selectively actuated along its axis 215 to selectively actuate the sleeve 162. The vertically extending shift rod 300 is connected to one arm of an L-shaped rocker 164. The other arm of the L-shaped rocker 164 is connected to a horizontal clutch rod 166 disposed within a bore defined along the forward end of the propeller shaft 146. The shift rod 300, the rocker 164, and the clutch rod 166 together form a shift assembly. The clutch rod 166 is connected to the sleeve 162 via a pin 168 extending through the rear end of the clutch rod 166, a slot in the propeller shaft 146 and the sleeve 162. When the shift rod 300 is pulled upward, the rocker 164 pivots, thereby pulling the clutch rod 166 forward (i.e. toward the right in FIG. 2 and toward the left in FIG. 3) which in turn pulls the sleeve 162 forward thereby engaging the bevel gear 147A of the transmission 145. Conversely, when the shift rod 300 is pushed downward, the rocker 164 pivots in the opposite direction, thereby pushing the clutch rod 166 rearward which pushes the sleeve 162 rearward, thereby engaging the bevel gear 147B of the transmission 145. The shift rod 300 will be described in greater detail below.

The electric transmission actuator assembly 202 is included in the gear case 140 to actuate the vertically extending shift rod 300. The electric transmission actuator assembly 202 has an electric motor 206 connected to an actuator 204 extending vertically downwards. The actuator 204 is actuated along an actuation axis 209 coinciding with a central axis of the actuator 204 and parallel to the axis 215 of the shift rod 300. The actuation of the actuator assembly 202 is controlled by providing appropriate logic signals to the electric motor 206. The actuator 204 engages an upper end of the shift rod 300. The actuator 204 actuates the sleeve 162 by actuating the shift rod 300 vertically along the central axis 215 of the shift rod 300. The actuator axis 209 is parallel to the driveshaft 144. It is contemplated that the actuation axis 209 could be at an angle to the driveshaft 144.

The actuator 204 shown in the figures is a linear actuator. It is contemplated that the actuator 204 could be a rotary actuator rotating about the actuation axis 209. For example, in one such implementation, a rotating shift rod comprises an eccentric projection that engages a clutch rod, thereby translating the pivoting motion of the shift rod into a translation of the clutch rod. Other configurations of the transmission 145 with different shifting mechanisms that can be actuated by a linear or rotary actuator to be in forward, reverse or neutral operating configurations of the gear case assembly are also contemplated.

The electric transmission actuator assembly 202 is housed in an actuator chamber 230. A portion of the propeller shaft 146 that is coupled to the sleeve 162 and the transmission 145 are housed in a transmission chamber 210. The shift rod 300 of the transmission 145 extends from the transmission chamber 210 into the actuator chamber 230 through an opening or passage 234 between the two chambers. The passage 234 is sealed by a seal 235 to prevent entry of oil and other fluids from the transmission chamber 210 into the actuator chamber 230.

The actuator chamber 230 extends downwards from an actuator opening 236 in the top surface of the gear case 140 as can be seen in FIG. 2. The electric transmission actuator assembly 202 is inserted into and removed from the actuator chamber 230 through the actuator opening 236 during assembly and disassembly of the gear case assembly 200. A cap 240 is provided to close the actuator opening 236 and seal the actuator assembly 202 therewithin. The cap 240 has a cable opening 252 leading to a conduit 254 for carrying cables. Cables from the electric transmission actuator assembly 202 pass through the conduit 254 and cable opening 252 for electrical connections with the onboard controls (not shown).

It is contemplated that the actuator assembly 202 could be disposed in the upper portion 132 or the midsection 143 of the outboard engine 100 and that the shift rod 300 could extend from the gear case 140 thereto. It is also contemplated that the electric transmission actuator assembly 202 could be replaced by another type of shift actuator such as a mechanical or hydraulic transmission actuator assembly used to translate the shift rod 300.

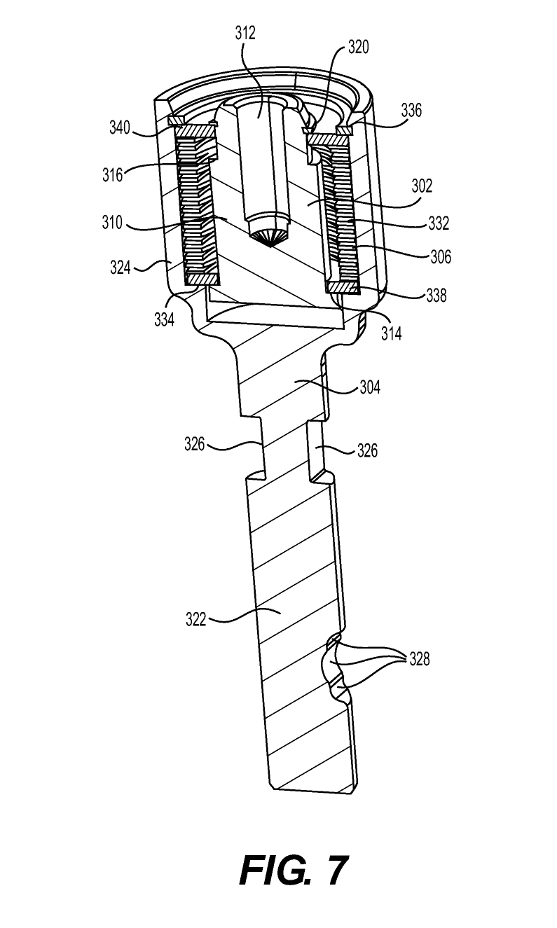

Turning now to FIGS. 3 to 7, the shift rod 300 will be described in more detail. The shift rod 300 has a shift rod portion 302, a shift rod portion 304 and a crest-to-crest wave spring 306. It is contemplated that the spring 306 could be replaced by another type of resilient member, such as for example a coil spring or Belleville washers. It is contemplated that the spring 306 could be made of a suitable metal or another type of resilient material. It is also contemplated that there could be more than one spring 306.

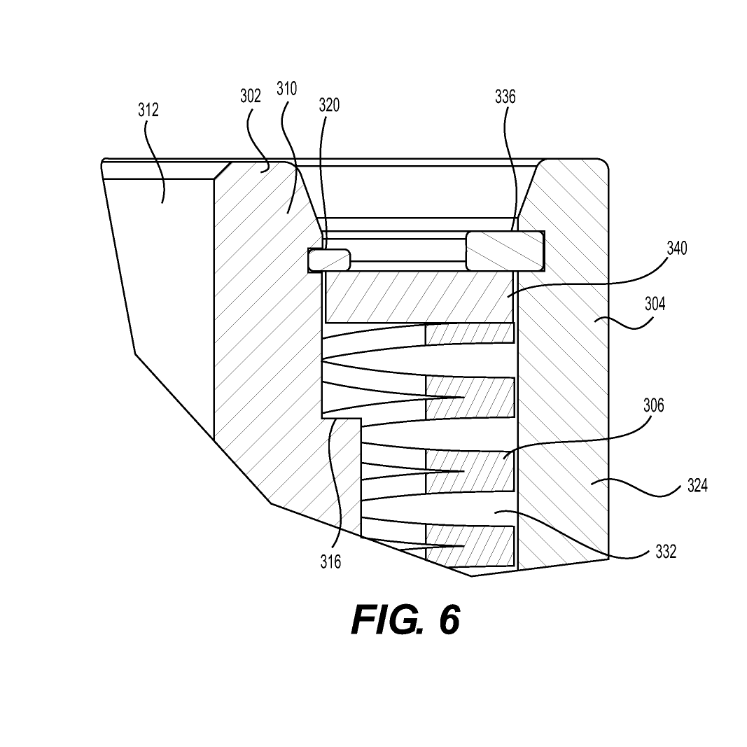

The shift rod portion 302 has a stem 308 connected to a stem attachment 310. The stem attachment 310 defines a threaded bore 312 inside which a threaded end of the stem 308 is fastened. It is contemplated that the stem 308 and the stem attachment 310 could be integrally formed or otherwise connected. The stem attachment 310 defines two upwardly facing abutment surfaces: a lower abutment surface 314 and an upper abutment surface 316. The stem attachment 310 also defines a bore receiving a pin 318 therein. As best seen in FIG. 6, the stem attachment 310 has a groove defined above the abutment surface 316 inside which is received a ring 320. The upper end of the stem 308 is connected to the actuator 204.

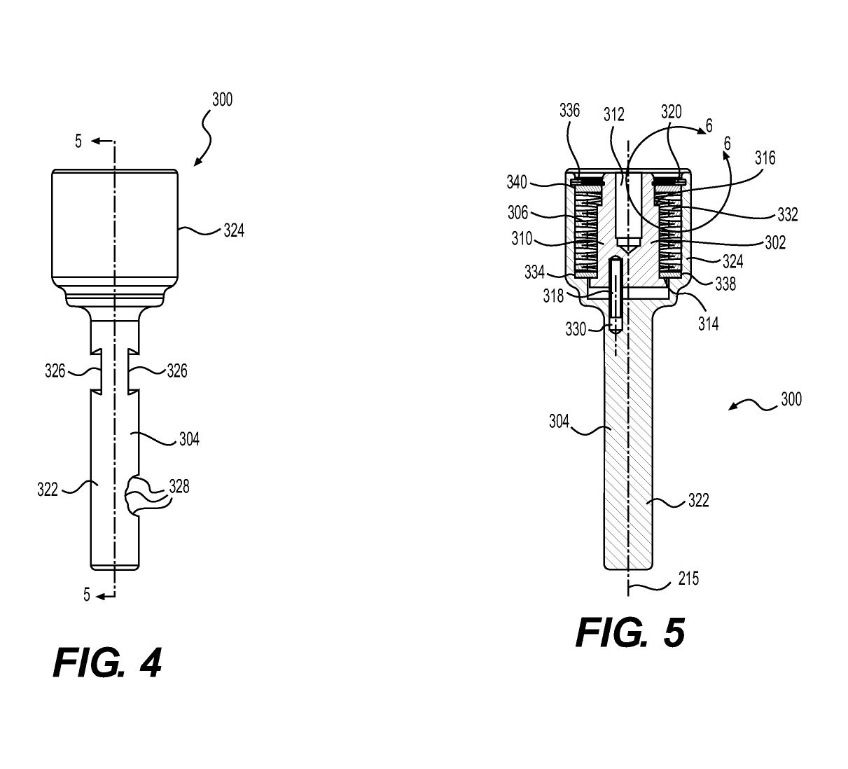

The shift rod portion 304 has a stem 322 connected to a cylindrical portion 324. The stem 322 and the cylindrical portion 324 are integrally formed, but it is contemplated that they could be two separate parts connected to each other. As best seen in FIG. 4, the stem 322 defines two grooves 326. The grooves 326 receive the generally horizontal arms of the rocker 164 slidably therein. The stem 322 also defines three depressions 328. Each depression 328 corresponds to a position of the shift rod 300 (i.e. forward, reverse or neutral shift). A spring loaded ball bearing (not shown) is mounted within the gear case 140 and biased against the depression 328 corresponding to the current position of the shift rod 300, thereby helping to maintain the shift rod 300 in position and providing some resistance to a change in shift position. As can be seen in FIG. 5, the stem 322 has a bore 330 in its upper end to slidably receive the pin 318 therein.

It is contemplated that one or more apertures could be defined in the sides of the cylindrical portion 324 near a bottom thereof to permit fluid to flow in and out of the space between the stem attachments 310 and the top of the stem 322. It is also contemplated that the bore defined in the stem attachment 310 for receiving the pin 318 could extend up to the bore 312 to communicate the bore 312 with the space between the stem attachments 310 and the top of the stem 322 and with the bore 330. By providing a hollow pin 318 in such an implementation, the space defined in the threaded bore 312 can communicate fluidly with the space between the stem attachments 310 and the top of the stem 322.

The cylindrical portion 324 defines a spring chamber 332 inside which a portion of the stem attachment 310, including the abutment surface 314, and, as will be described below, the spring 306 are received. The cylindrical portion 324 defines an upwardly facing abutment surface 334. As best seen in FIG. 6, the cylindrical portion 324 has a groove inside which a ring 336 is received. It is contemplated that apertures could be defined in the sides of the cylindrical portion 324 in alignment with the spring chamber 332 to permit fluid to flow in and out of the spring chamber 332.

The spring 306 is disposed inside the spring chamber 332 around the stem attachment 310. A washer 338 is disposed between the lower end of the spring 306 and the abutment surfaces 314, 334. A washer 340 is disposed between the upper end of the spring 306 and the retaining rings 320, 336. In the position shown in the figures, the spring 306 is partially compressed and is biased against the washers 338, 340.

It is contemplated that the shift rod portion 302 could have the cylindrical portion 324 and that the shift rod portion 304 could have the stem attachment 310.

As explained in greater detail below, this arrangement allows movement of the shift rod portion 302 relative to the shift rod portion 304 along the axis 215. The pin 318, whose lower end is received in the bore 330 and free to translate therein in a direction parallel to the axis 215, limits the rotation of the shift rod portion 302 relative to the shift rod portion 304 about the axis 215.

The shift rod 300 shown in FIGS. 3 to 7 is in an unloaded state, that is to say that the shift rod portions 302, 304 are positioned relative to one another as they are when at rest and without external forces acting on either one. The spring 306, however, is pre-loaded when the shift rod 300 is in this state, that is to say it is partially compressed between the washers 338, 340. The spring 306 pushes the washer 338 downwards against the lower abutment surfaces 314, 334 of the stem attachment 310 and the cylindrical portion 324, respectively. At the same time, the spring 306 pushes the washer 340 upwards against the retaining rings 320, 336. The spring 306 is prevented from extending beyond the length shown in FIGS. 3 to 7 by the abutment surface 334 and the retaining ring 336 which are at a fixed distance from one another.

When the transmission 145 is in the neutral position (i.e. the sleeve 162 does not engage the bevel gears 147A, 147B), the shift rod 300 is in the unloaded state shown in FIGS. 3 to 7.

When the shift rod 300 is lifted up in order to cause engagement of the bevel gear 147A, should the teeth of the sleeve 162 be misaligned with the spaces between the teeth of the bevel gear 147A, the shift rod portion 302 moves up relative to the shift rod portion 304. As the shift rod portion 302 moves up relative to the shift rod portion 304, the retaining ring 320 moves up relative to the washer 340 and the abutment surface 314 of the stem attachment 310 lifts the washer 338 from the abutment surface 334 of the cylindrical portion 324, thereby compressing the spring 306 between the washers 338, 340. The shift rod portion 302 moves up relative to the shift rod portion 304 until the abutment surface 316 comes into contact with the washer 340 or the teeth of the sleeve 162 become aligned with the spaces between the teeth of the bevel gear 147A. When the teeth of the sleeve 162 become aligned with the spaces between the teeth of the bevel gear 147A, the spring 306 pushes up on the washer 340, which in turn pushes on the retaining ring 336, thereby lifting the shift rod portion 304 until the washer 340 abuts the retaining ring 320 and the abutment surface 334 abuts the washer 338, thereby returning the shift rod 300 to the unloaded state shown in FIGS. 3 to 7. As the shift rod 304 is lifted up, the sleeve 162 engages the bevel gear 147A.

When the shift rod 300 is pushed downward in order to cause engagement of the bevel gear 147B, should the teeth of the sleeve 162 be misaligned with the spaces between the teeth of the bevel gear 147B, the shift rod portion 302 moves down relative to the shift rod portion 304. As the shift rod portion 302 moves down relative to the shift rod portion 304, the abutment surface 314 move down relative to the washer 338 and the retaining ring 320 pushes the washer 340 down and away from the retaining ring 336 of the cylindrical portion 324, thereby compressing the spring 306 between the washers 338, 340. The shift rod portion 302 moves down relative to the shift rod portion 304 until the bottom of the stem attachment 310 comes into contact with the top of the stem 322 or the teeth of the sleeve 162 become aligned with the spaces between the teeth of the bevel gear 147B. When the teeth of the sleeve 162 become aligned with the spaces between the teeth of the bevel gear 147B, the spring 306 pushes down on the washer 338, which in turn pushes on the abutment surface 334, thereby lowering the shift rod portion 304 until the washer 338 abuts the abutment surface 314 and the retaining ring 336 abuts the washer 340, thereby returning the shift rod 300 to the unloaded state shown in FIGS. 3 to 7. As the shift rod 304 is lowered, the sleeve 162 engages the bevel gear 147B.

It is contemplated that, depending on the stiffness of the spring 306, there could also be slight compression of the spring 306, and therefore relative motion of the shift rod portions 302, 304, when moving the shift rod 300 even when the teeth of the sleeve 162 are aligned with the spaces between the teeth of the bevel gear 147A or 147B, depending on the direction of actuation, as some mechanical resistance may need to be overcome in order to achieve the shifting. In the present implementation, preloading and stiffness of the spring 306 are selected such that, unless there is misalignment with the teeth of the gears 147A, 147B as described above, the shift rod portions 302, 304 move up and down together as a unit.

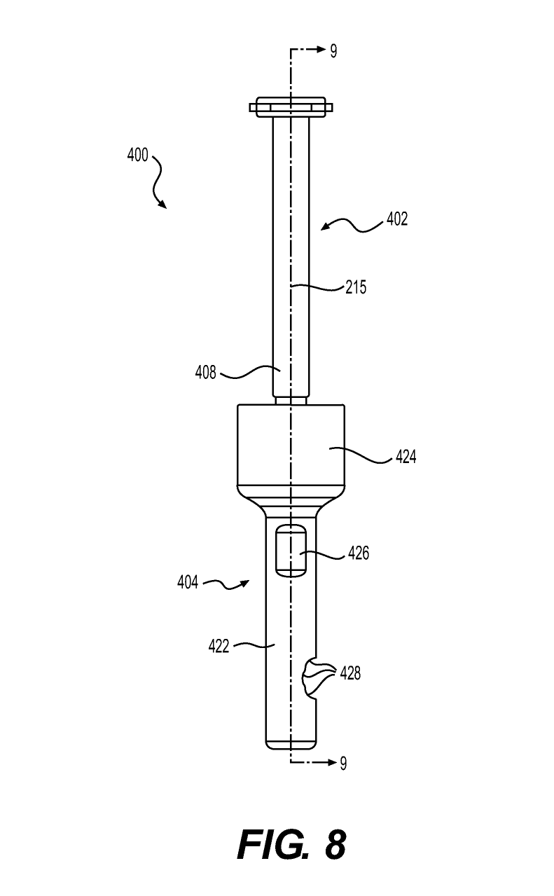

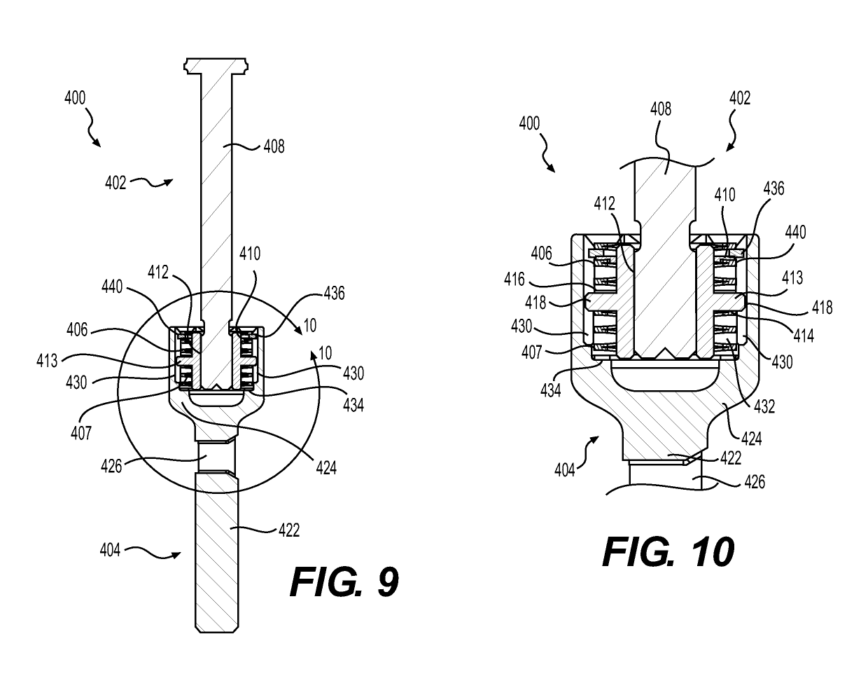

Turning now to FIGS. 8 to 10, a shift rod 400, which is an alternative implementation of the shift rod 300, will be described in detail. The shift rod 400 has a shift rod portion 402, a shift rod portion 404, a crest-to-crest wave spring 406, and a crest-to-crest wave spring 407. It is contemplated that the springs 406, 407 could be replaced by other types of resilient members, such as for example coil springs or Belleville washers. It is also contemplated that there could be more than one of each spring 406 and 407.

The shift rod portion 402 has a stem 408 connected to a stem attachment 410. The stem attachment 410 defines a threaded bore 412 inside which a threaded end of the stem 408 is fastened. It is contemplated that the stem 408 and the stem attachment 410 could be integrally formed or otherwise connected. The stem attachment 410 has a flange 413 defining a lower abutment surface 414 and an upper abutment surface 416. The flange 413 also defines protrusions 418 extending from the end thereof for preventing the stem attachment 410 from rotating with respect to the shift rod portion 404, as will be discussed in further detail herein below.

The shift rod portion 404 has a stem 422 connected to a cylindrical portion 424. The stem 422 and the cylindrical portion 424 are integrally formed, but it is contemplated that they could be two separate parts connected to each other. As best seen in FIG. 8, the stem 422 defines an aperture 426. In the present implementation, the rocker 164 has a single horizontal arm and the aperture 426 receives the generally horizontal arm of the rocker 164 slidably therein. It is contemplated that the aperture 426 could be replaced with one or more grooves 326 as in the shift rod 300 described above. The stem 422 also defines three depressions 428. Each depression 428 corresponds to a position of the shift rod 400 (i.e. forward, reverse or neutral shift). A spring loaded ball bearing (not shown) is biased against the depression 428 corresponding to the current position of the shift rod 400, thereby helping to maintain the shift rod 400 in position and providing some resistance to a change in shift position.

As best seen in FIG. 10, the cylindrical portion 424 has grooves 430 to slidably receive the protrusions 418 therein. Various complementary protrusions 418 and grooves 430 combinations are possible. For example in one implementation the flange 413 is hexagonal in shape and forms six protrusions 418 which are received in six complementary grooves 430. The cylindrical portion 424 defines a spring chamber 432 inside which the stem attachment 410, including the flange 413, and, as will be described below, the springs 406, 407 are received. The cylindrical portion 424 defines an upwardly facing abutment surface 434. As best seen in FIG. 10, the cylindrical portion 424 has a groove inside which is received a retaining ring 436.

The spring 406 is disposed inside the spring chamber 432 around the stem attachment 410 above the flange 413. A washer 440 is disposed between the upper end of the spring 406 and the ring 436. The lower end of the spring 406 abuts the upper abutment surface 416 of the flange 413. The spring 407 is disposed inside the spring chamber 432 around the stem attachment 410 below the flange 413. The lower end of the spring 407 abuts the abutment surfaces 434 and the upper end of the spring 407 abuts the lower abutment surface 414 of the flange 413. In the position shown in the figures, the springs 406, 407 are slightly compressed.

It is contemplated that one or more apertures could be defined in the side of the cylindrical portion 424 in alignment with the spring chamber 432 to permit fluid to flow in and out of the spring chamber 432. It is also contemplated that apertures could be defined in the side of the cylindrical portion 424 in alignment with the space defined between the bottom of the stem 408 and the top of the stem 422 to permit fluid to flow in and out of this space.

It is contemplated that the shift rod portion 402 could have the cylindrical portion 424 and that the shift rod portion 404 could have the stem attachment 410.

As explained in greater detail below, this arrangement allows movement of the shift rod portion 402 relative to the shift rod portion 404 along the axis 215. The engagement of the protrusions 418 in the grooves 430 limits the rotation of the shift rod portion 402 relative to the shift rod portion 404 about the axis 215.

When the transmission 145 is in the neutral position (i.e. the sleeve 162 does not engage the bevel gears 147A, 147B), the shift rod 400 is as shown in FIGS. 8 to 10. As mentioned above, the spring 406 is slightly compressed and therefore presses against the lower face of the washer 440 and the upper face of the flange 413, thereby biasing the washer 440 against the retaining ring 436. Similarly, the spring 407 presses against the lower face of the flange 413 and the abutment surface 434. Therefore the stem attachment 410 is biased in the position shown by the springs 406, 407.

When the shift rod 400 is lifted up in order to cause engagement of the bevel gear 147A, should the teeth of the sleeve 162 be misaligned with the spaces between the teeth of the bevel gear 147A, the shift rod portion 402 moves up relative to the shift rod portion 404. As the shift rod portion 402 moves up relative to the shift rod portion 404, the spring 406 is further compressed between the washer 440 and the upper abutment surface 416 of the flange 413. The shift rod portion 402 moves up relative to the shift rod portion 404 until the spring 406 is fully compressed or the teeth of the sleeve 162 become aligned with the spaces between the teeth of the bevel gear 147A. When the teeth of the sleeve 162 become aligned with the spaces between the teeth of the bevel gear 147A, the spring 406 pushes up on the washer 440, which in turn pushes on the ring 436, thereby lifting the shift rod portion 404 and returning the shift rod 400 to the unloaded state shown in FIGS. 8 to 10. As the shift rod 404 is lifted up, the sleeve 162 engages the bevel gear 147A.

When the shift rod 400 is pushed downward in order to cause engagement of the bevel gear 147B, should the teeth of the sleeve 162 be misaligned with the spaces between the teeth of the bevel gear 147B, the shift rod portion 402 moves down relative to the shift rod portion 404. As the shift rod portion 402 moves down relative to the shift rod portion 404, the spring 407 is compressed between the abutment surfaces 414 and 434. The shift rod portion 402 moves down relative to the shift rod portion 404 until the bottom of the stem attachment 410 comes into contact with the top of the stem 422 or the teeth of the sleeve 162 become aligned with the spaces between the teeth of the bevel gear 147B. When the teeth of the sleeve 162 become aligned with the spaces between the teeth of the bevel gear 147B, the spring 407 pushes down on the abutment surface 434, thereby lowering the shift rod portion 404 and returning the shift rod 400 to the unloaded state shown in FIGS. 8 to 10. As the shift rod 404 is lowered, the sleeve 162 engages the bevel gear 147B.

It is contemplated that, depending on the stiffness of the springs 406, 407, there could also be slight compression of the spring 406 or 407, and therefore relative motion of the shift rod portions 402, 404, when moving the shift rod 400 even when the teeth of the sleeve 162 are aligned with the spaces between the teeth of the bevel gear 147A or 147B, depending on the direction of actuation, as some mechanical resistance may need to be overcome in order to achieve the shifting. In the present implementation, the preloading and stiffness of the springs 406, 407 are selected such that, unless there is misalignment with the teeth of the gears 147A, 147B as described above, the shift rod portions 402, 404 move up and down together as a unit.

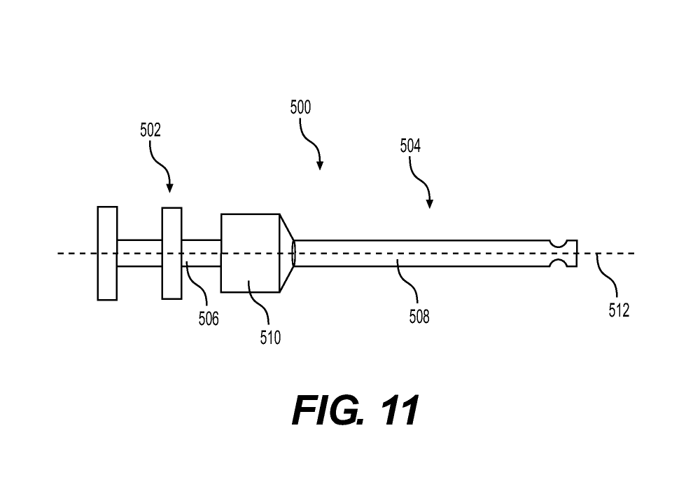

FIG. 11 illustrates a clutch rod 500 used in an alternative implementation of the shift assembly of the outboard engine 100. In the alternative implementation of the shift assembly, the shift rod is a single stem or a plurality of interconnected stems that are not movable relative to each other.

The clutch rod 500 has a clutch rod portion 502, a clutch rod portion 504, and one or more resilient members (not shown), such as one or more springs, operatively connecting the clutch rod portion 502, 504. The clutch rod portion 502 has a stem 506 connected to a stem attachment (not shown). The clutch rod portion 504 has a stem 508 connected to a cylindrical portion 510. The clutch rod portion 502 is movable relative to the clutch rod portion 504 along the axis 512.

In one implementation of the clutch rod 500, the connection between the clutch rod portions 502, 504 is similar to the connection between the shift rod portions 302, 304 described above. In another implementation of the clutch rod 500, the connection between the clutch rod portions 502, 504 is similar to the connection between the shift rod portions 402, 404 described above.

In other non-illustrated implementations of a shift assembly, the shift rod is a single stem or a plurality of interconnected stems that are not movable relative to each other and the clutch rod is a single stem (as the clutch rod 166 shown in FIG. 2) or a plurality of interconnected stems that are not movable relative to each other. In one such implementation, the rocker transmitting motion from the shift rod to the clutch rod is made of a resilient material and therefore acts as the resilient member. In another such implementation, the generally horizontal arm of the L-shaped rocker is pivotally connected to the generally vertical arm of the L-shaped rocker and a spring biases the two arms to form the L-shape. In yet another such implementation, the rocker is similar to the rocker 166 described above and a resilient member is connected between the lower end of the shift rod and the generally horizontal arm of the L-shaped rocker. In yet another such implementation, the rocker is similar to the rocker 166 described above and a resilient member is connected between the forward end of the clutch rod and the generally vertical arm of the L-shaped rocker.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A gear case assembly for an outboard engine for propelling a watercraft, the outboard engine having a shift actuator, the gear case assembly comprising:
a gear case;
a driveshaft, a part of the driveshaft being disposed within the gear case;
a bevel gear connected to the part of the driveshaft and being rotatable therewith, the bevel gear being disposed within the gear case;
a propeller shaft disposed at least in part within the gear case and at an angle to the driveshaft; and
a transmission being operatively connected to the bevel gear, the bevel gear selectively driving the propeller shaft via the transmission, the transmission comprising:
a forward gear operatively connected to the bevel gear for selectively driving the propeller shaft in a first direction of rotation for propelling the watercraft in a forward direction;
a reverse gear operatively connected to the bevel gear for selectively driving the propeller shaft in a second direction of rotation opposite the first direction of rotation for propelling the watercraft in a reverse direction; and
a shift assembly being adapted for actuation by the shift actuator for the selective driving of the propeller shaft by one of the forward and reverse gears, the shift assembly including a first rod portion, a second rod portion and at least one resilient member, the at least one resilient member operatively connecting the first rod portion to the second rod portion, the first rod portion being movable relative to the second rod portion.

2. The gear assembly of claim 1, wherein the shift assembly comprises:
a shift rod disposed parallel to the driveshaft and being disposed at least in part within the gear case, the shift rod being adapted for actuation by the shift actuator;
a clutch rod disposed at an angle to the shift rod; and
a rocker operatively connecting the shift rod to the clutch rod for transferring motion of the shift rod to the clutch rod;
wherein one of the shift rod and the clutch rod includes the first rod portion, the second rod portion and the at least one resilient member.

3. The gear case assembly of claim 2, wherein the at least one resilient member is at least one spring.

4. The gear case assembly of claim 3, wherein:
the shift rod has the first rod portion, the second rod portion and the at least one spring;
the first rod portion is a first shift rod portion and the second rod portion is a second shift rod portion;
the first shift rod portion has a first abutment surface;
the second shift rod portion has a second abutment surface and defines a spring chamber;
the first abutment surface of the first shift rod portion is received in the spring chamber; and
at least one of the at least one spring is disposed in the spring chamber between the first and second abutment surfaces.

5. The gear case assembly of claim 4, further comprising a first washer disposed between the first abutment surface and the at least one of the at least one spring; and
wherein the second abutment surface is defined by a second washer.

6. The gear case assembly of claim 4, further comprising a pin inserted in the first and second shift rod portions and preventing rotation of the first and second shift rod portions relative to each other about an actuation axis of the shift rod assembly.

7. The gear case assembly of claim 4, wherein:
the at least one of the at least one spring is disposed on a first side of the first abutment surface; and
at least another one of the at least one spring is disposed in the spring chamber between the first abutment surface and the second shift rod portion on a second side of the first abutment surface.

8. The gear case assembly of claim 1, further comprising the shift actuator, the shift actuator comprising an electric transmission actuator assembly selectively actuating the shift assembly;
wherein the gear case has an actuator chamber housing at least part of the electric transmission actuator assembly.

9. The gear case assembly of claim 2, wherein the shift rod is actuated linearly about an actuation axis parallel to the driveshaft.

10. The gear case assembly of claim 2, wherein:
the clutch rod has the first rod portion, the second rod portion and the at least one resilient member;
the first rod portion is a first clutch rod portion and the second rod portion is a second clutch rod portion.

11. An outboard engine for propelling a watercraft, the outboard engine comprising:
a cowling;
an engine disposed in the cowling;
a driveshaft disposed in the cowling, the driveshaft having at least an upper section and a lower section, the upper section of the driveshaft being operatively connected to the engine;
a gear case connected to the cowling, a part of the lower section of the driveshaft being disposed within the gear case;
a bevel gear connected to the part of the lower section of the driveshaft and being rotatable therewith, the bevel gear being disposed within the gear case;
a propeller shaft disposed at least in part within the gear case and at an angle to the driveshaft;
a bladed rotor connected to the propeller shaft; and
a transmission being operatively connected to the bevel gear, the bevel gear selectively driving the propeller shaft via the transmission, the transmission comprising:
a forward gear selectively operatively connected to the bevel gear for driving the propeller shaft in a first direction of rotation for propelling the watercraft in a forward direction;
a reverse gear selectively operatively connected to the bevel gear for driving the propeller shaft in a second direction of rotation opposite the first direction of rotation for propelling the watercraft in a reverse direction; and
a shift actuator operatively connected to a shift assembly, the shift actuator being adapted for actuating the shift assembly for the selective driving of the propeller shaft by one of the forward and reverse gears, the shift assembly including a first rod portion, a second rod portion and at least one resilient member, the at least one resilient member operatively connecting the first rod portion to the second rod portion, the first rod portion being movable relative to the second rod portion.

12. The outboard engine of claim 11, wherein the shift assembly comprises:
a shift rod disposed parallel to the driveshaft and being disposed at least in part within the gear case, the shift rod being adapted for actuation by the shift actuator;
a clutch rod disposed at an angle to the shift rod; and
a rocker operatively connecting the shift rod to the clutch rod for transferring motion of the shift rod to the clutch rod;
wherein one of the shift rod and the clutch rod includes the first rod portion, the second rod portion and the at least one resilient member.

13. The outboard engine of claim 12, wherein the at least one resilient member is at least one spring.

14. The outboard engine of claim 13, wherein:
the shift rod has the first rod portion, the second rod portion and the at least one spring;
the first rod portion is a first shift rod portion and the second rod portion is a second shift rod portion;
the first shift rod portion has a first abutment surface;
the second shift rod portion has a second abutment surface and defines a spring chamber;
the first abutment surface of the first shift rod portion is received in the spring chamber; and
at least one of the at least one spring is disposed in the spring chamber between the first and second abutment surfaces.

15. The outboard engine of claim 14, further comprising a first washer disposed between the first abutment surface and the at least one of the at least one spring; and
wherein the second abutment surface is defined by a second washer.

16. The outboard engine of claim 14, further comprising a pin inserted in the first and second shift rod portions and preventing rotation of the first and second shift rod portions relative to each other about an actuation axis of the shift rod assembly.

17. The outboard engine of claim 14, wherein:
the at least one of the at least one spring is disposed on a first side of the first abutment surface; and
at least another one of the at least one spring is disposed in the spring chamber between the first abutment surface and the second shift rod portion on a second side of the first abutment surface.

18. The outboard engine of claim 11, wherein the shift actuator comprises an electric transmission actuator assembly selectively actuating the shift assembly;
wherein the gear case has an actuator chamber housing at least part of the electric transmission actuator assembly.

19. The outboard engine of claim 12, wherein the shift rod is actuated linearly about an actuation axis parallel to the driveshaft.

20. The outboard engine of claim 12, wherein:
the clutch rod has the first rod portion, the second rod portion and the at least one resilient member;
the first rod portion is a first clutch rod portion and the second rod portion is a second clutch rod portion.
